(19) United States
(12) Patent Application Publication
(10) Pub. No.: US 2009/0072558 A1
(43) Pub. Date: Mar. 19, 2009

(54) Fully disposable combination shovel and bag unit for pet waste pickup and disposal

(76) Inventors: Robert Hanson, Mountainside, NJ (US); William Ilaria, Cranford, NJ (US)

Correspondence Address: Robert Hanson, 16 Tanglewood Lane, Mountainside, NJ, 07092, US

(21) Appl. No.: 12/221,185

(22) Filed: Jul. 31, 2008

Related U.S. Application Data
(60) Provisional application No. 60/962,639, filed on Jul. 31, 2007.

(51) Int. Cl. A01K 29/00

(52) U.S. Cl. 294/1.3

(57) ABSTRACT

A fully assembled, totally disposable one-piece device for the sanitary collection and disposal of feces from an animal or pet intended to be discarded after one use. The device includes a plastic bag with handles attached to a cardboard shovel blade. The plastic bag is open at the end opposite the shovel blade. The open end of the bag is partially turned inside-out as it slips over the operator's hand and up the wrist and forearm. Once the animal waste is shoveled up, the bag is pulled completely inside-out over the mouth of the shovel completely encapsulating the blade and feces. The open end is tied utilizing the handles providing for easy carrying. The entire device is then discarded.

### CROSS-REFERENCED TO RELATED APPLICATIONS

Provisional Patent Application No. 60/962,639, filed Jul. 31, 2007, by Willaim Ilaria and Robert Hanson, titled: Fully disposable combination shovel and bag unit for pet waste pickup and disposal

### FEDERALLY SPONSORED RESEARCH

None

### BACKGROUND OF THE INVENTION

This invention relates to the collection and disposal of pet waste and enables pet owners to scoop up waste without touching, feeling or coming in contact with the pet waste in any way, to ensure all waste and contaminated parts are fully enclosed inside a sealed bag, and to easily and fully dispose of the waste and device.

This invention relates to other disposable scooping devices made of either cardboard, plastic, plastic bags or combinations of all three. These devices are often complex to use, require assembly, require scraping the device along the feces and/or ground, versus shoveling it, which is the more natural method of picking up pet waste, permit exposure to contaminated parts, or obliges operator to feel the feces through a bag.

This fully assembled, fully disposable device has three components, a shovel, a bag, and a bag closure method that traps waste and all contaminated parts in an inside-out, sealed bag. Other devices have some, but not all of these components.

### DESCRIPTION OF THE PRIOR ART

Many city ordinances require that dog owners pick-up after their dogs. There are many methods of picking up and disposing of dog waste. Many devices and prior art have been developed to address the issue. The most common method, picking up waste using an inverted plastic shopping bag, requires pet owners to grasp the dog waste through the plastic bag, feeling the contents in the process. Other methods require the use of newspapers, garden shovels, or other generic devices to scoop and dispose of the waste. These methods require: contact with the waste, feeling the waste, transferring the waste to a disposable unit, post use clean-up and/or storage of collection device.

Much prior art has been developed:
Re-usable shovels & devices have several limitations by their very nature. Reusable devices tend to be bulky, awkward to carry and require a storage space for the device as in U.S. Pat. No. 4,383,710 to Fehr; some employ disposable bags but are complex to load and operate as in U.S. Pat. No. 6,123,046 to Gemeniano; some reusable devices utilize blades that can puncture the collection bag and thus require a thorough cleansing after each use as in U.S. Pat. No. 3,813,121 to Marvin.
Some pet waste collection devices contain multiple parts and are only partially disposable, as in U.S. Pat. No. 7,267,381 to Cafferty and U.S. Pat. No. 5,370,431 to Henninger, where only the bag is disposable.
Disposable devices also have limitations and differ from the present invention. Some disposable prior art contain multiple pieces and lack complete seal after using, as in U.S. Pat. No. 4,715,495 to Henry and U.S. Pat. No. 4,186,955 to Campbell.
Some disposable prior art is bulky and not easy to carry or fit easily into the operator's pocket prior to use as in U.S. Pat. No. 5,564,763 to Mercurio and U.S. Pat. No. 6,048,008 to Shaw.
Some prior art obliges the owner to feel the dog waste through a bag or shaped piece of plastic as in U.S. Pat. No. 6,116,668 to Carpol.
Other prior art requires mechanical assembly or operation leaving operator's hand exposed to possible contamination as in U.S. Pat. No. 4,830,419 to Watanabe.
Others maintain a partially open end and incomplete seal mechanism, thus creating possibility of leakage of waste and/or odors as in U.S. Pat. No. 3,676,887 to Klein.
Still other disposable devices leave an exposed portion that may come in contact with dog waste and do not seal the waste and scoop completely in their disposable containers as in U.S. Pat. No. 4,230,354 to Claras.
Some disposable prior art omit a shovel blade which facilitates a natural shovel movement employing the operator's extended arm, but rather rely upon coordination with an external animal waste collection device as in U.S. Pat. No. 7,192,190 to Jung.

### SUMMARY

The invention, a one-piece, fully assembled, fully disposable combination shovel and bag device for retrieving, handling and disposing of pet waste in a sanitary manner, is structured to provide an easy, economical, effective method for pickup and containment of waste while preventing direct contact between operator and waste. The invention places two barriers between operator and waste, eliminates the possibility of waste coming in contact with operator and protects the operator from feeling the waste. The fully disposable collection unit is comprised of die-cut cardboard portion, folded upon itself to form a chute, and plastic sheet material formed into a collection bag with carrying handles, such that closed end of bag and base of flattened chute are permanently attached to form a single collection unit. A key element of difference from prior art is that the operator starts with a shovel attached to a collection bag partially turned inside-out; once pickup is complete, operator completes the inside-out action on the bag, thus encapsulating the waste, all contamination and the device in a bag with handles, that when tied, provide a complete seal.

### DRAWINGS

FIG. 1 is a front view of the disposable shovel & bag unit with bag permanently attached to chute.

FIG. 2 is a back view of the disposable shovel & bag unit showing the location of permanent attachment of closed end of bag to chute.

FIG. 3 shows the die-cut cardboard piece prior to being folded.

FIG. 4 shows the disposable unit in operator's hand ready for use.

FIG. 5 is a view of operator and device after it has been used to pickup waste.

### DETAILED DESCRIPTION

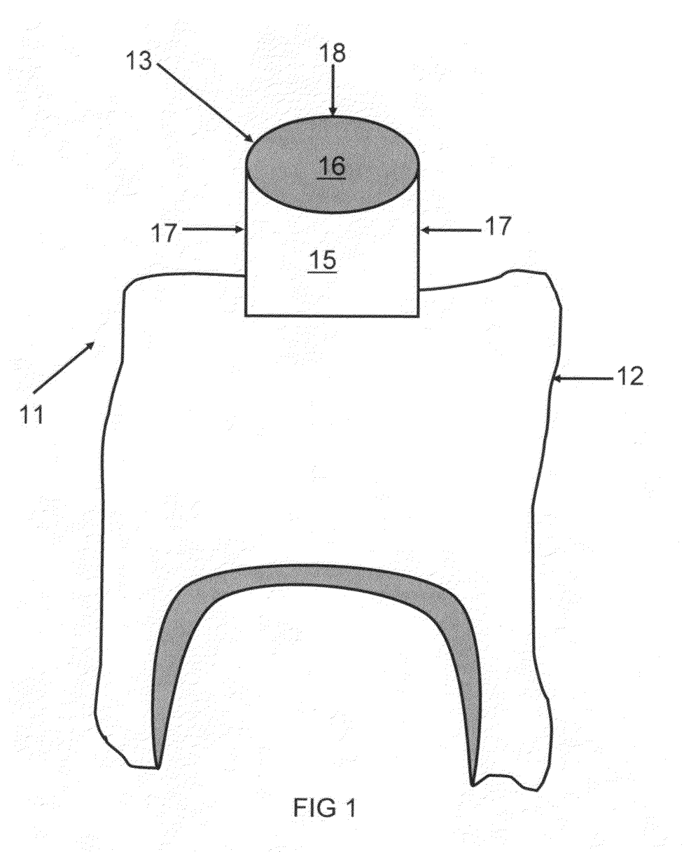

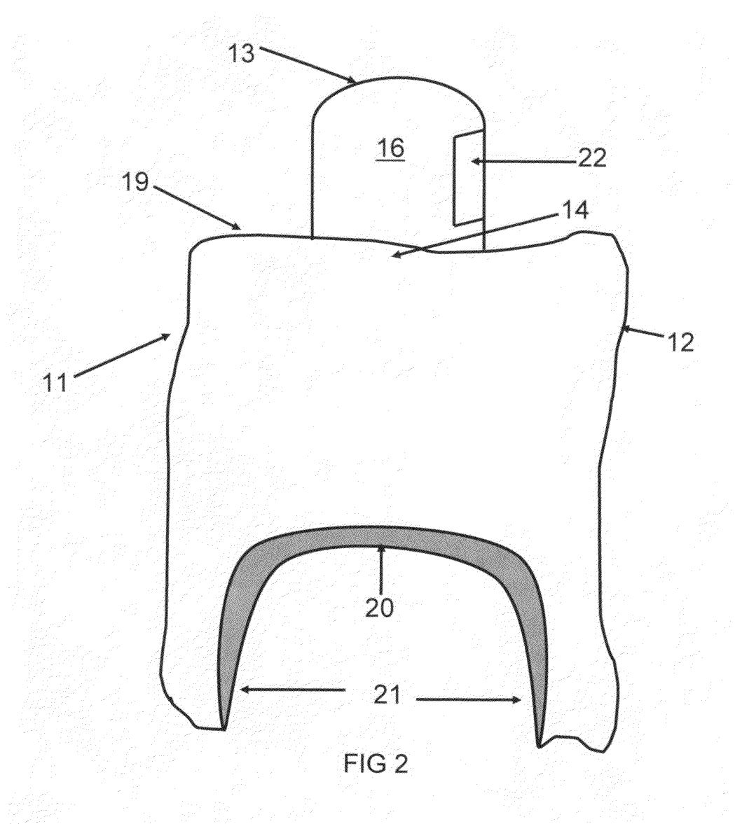

FIG. 1 is a front view of the disposable shovel & bag unit 11 with bag 12 permanently attached to chute 13 at location 14 (see FIG. 2). Chute's top layer 15 is shorter than bottom layer 16 such that, when sides 17 of chute are gently squeezed top 15 and bottom 16 layers separate, and a rounded shovel blade 18 is formed on the bottom layer 16.

FIG. 2 is a back view of the disposable shovel & bag unit 11 showing the location 14 of attachment of closed end 19 of bag 12 to chute 13 and the elongated flap 22 that laps and secures the top 15 (see FIG. 1) and bottom 16 layers of chute. Preferred method of bag attachment is with glue, tape or thermal seal. At the other end of disposable unit 11 is the open end 20 of bag 12 and tie handles 21.

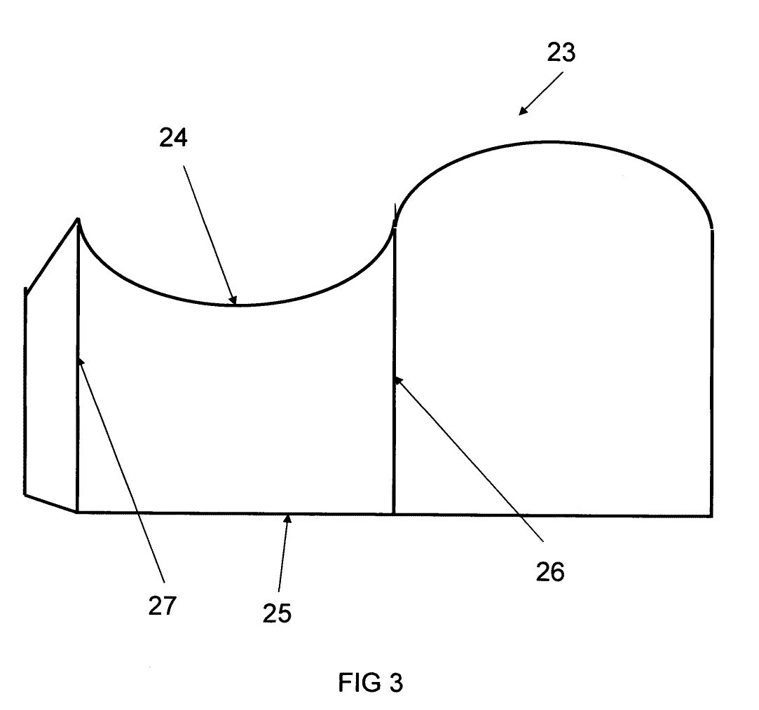

FIG. 3 shows the die-cut cardboard piece 23 prior to being folded along vertical score lines at locations 26 and 27. The top edge 24 of die-cut is approximately S-shaped and the bottom edge 25 is flat.

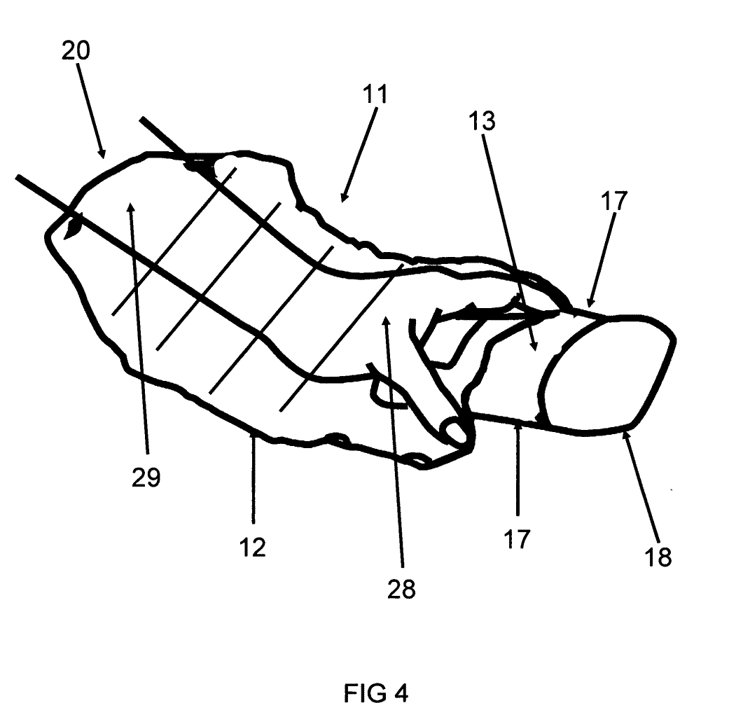

FIG. 4 shows the disposable shovel & bag unit 11 being used, with bag 12 partially turned inside-out. The operator's hand 28 and arm 29 slide into the open end 20 of bag 12 and operator's hand 28 grasps the sides 17 of chute 13, gently squeezing to form open-ended chute with shovel blade 18 on leading edge.

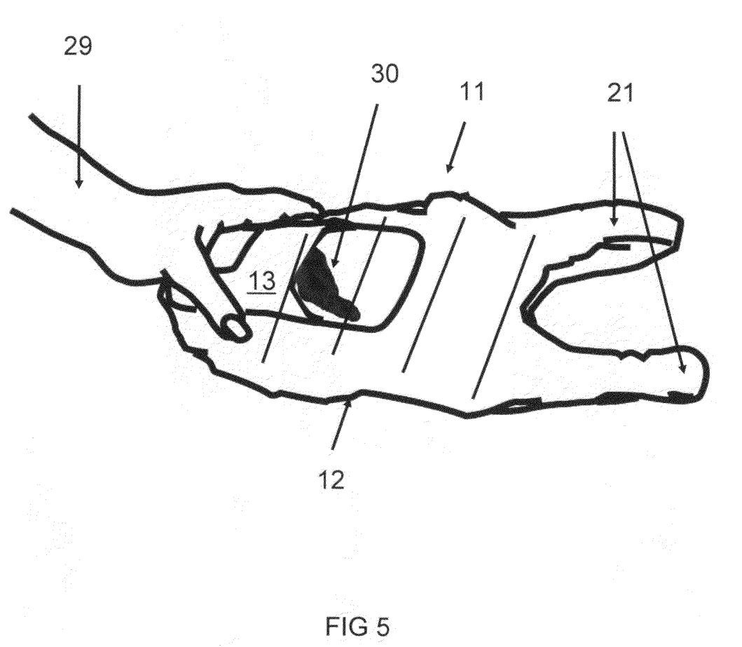

FIG. 5 is a view of operator and disposable shovel & bag unit 11 after it has been used to pickup waste 30, and operator using free hand (not shown) has pulled bag 12 completely inside-out and off arm 29 and over chute 13 with tie handles 21 available to secure bag 12, chute 13 and waste 30.

### REFERENCE NUMERALS

11 disposable shovel & bag unit
12 bag
13 chute
14 location of permanent attachment of bag to chute
15 top layer of chute
16 bottom layer of chute
17 sides of chute
18 shovel blade
19 closed end of bag
20 open end of bag
21 tie handles
22 elongated flap
23 die-cut cardboard piece
24 top edge of die-cut cardboard piece
25 bottom edge of die-cut cardboard piece
26 score line
27 score line
28 operator's hand
29 operator's arm
30 pet waste

### OPERATION

In commercialized form the chute and bag are attached to form one fully assembled, one-piece, functioning unit. There is no assembly required by the operator.

The operator places a hand and arm far enough into the open end of bag to reach closed end of bag and starts to turn bag inside-out by sliding hand over base of flattened chute, grasping sides of flattened chute through the partially inside-out bag. The operator gently squeezes sides to form an open-ended chute with rounded shovel blade on leading edge facing away from operator. The formed shovel blade is slid under the material to be retrieved, channeling the waste through the chute into the bag avoiding direct contact or touch or feeling between operator's hand and waste. Once retrieved waste is in bag, operator uses free hand to pull open end of bag off the arm and over chute and waste, and secures the now completely inside-out bag by tying the carrying handles prior to discarding the entire device.

The chute is formed from die-cut, scored, thin cardboard sheet. In its unassembled position the die-cut is flat across bottom edge and S-curved across top edge such that when folded upon itself along vertical score line, the top layer of the flattened piece is shorter than the bottom layer and the front edge of the bottom layer is exposed to form a rounded shovel blade. The board has an elongated edge on one side such that when folded along vertical score line, it laps and secures the folded layers.

The bag is formed from a plastic material. The bottom of the bag is permanently attached with adhesive to the outside of the flattened chute approximately one inch up from bottom of chute.

1. A fully disposable waste pickup device comprising a cardboard portion formed in the shape of a flattened chute used to pick up and channel waste material by operator manually squeezing sides of flattened chute which adds the attribute of a rounded shovel blade, and
an opaque bag portion, with tie-off handles, permanently attached to the flattened chute to contain the waste,
whereby
in first stage of usage, the bag is partially turned inside-out by operator and
the combination of shovel and bag results in a one-piece device arranged is such a way that operator's hand remains separated from the waste by the double protection barrier of inside-out bag and the cardboard, thus permitting pickup and containment of waste while preventing any contact between the operator's hand and the waste and also avoiding the sensation of feeling as if picking up waste barehanded, and
the combination of shovel and bag results in a fully assembled pickup device, and
the chute, when squeezed to add attribute of rounded shovel blade, becomes a natural extension of the hand and arm facilitating easy scooping and pickup of waste of varying sizes and consistencies from differing surfaces (such as, but not limited to, street surface, sidewalk, hard dirt, soft dirt, soft grass, wet grass), and
in final stage of usage, the bag is turned completely inside-out, and
the bag having tie-off handles can be sealed and tied to minimizes odor transmission while providing a mechanism for easily carrying the device until disposal, and
the combination of bag and shovel is produced of materials sized such that entire device fits conveniently in operator's pocket prior to use, and
the combination of bag and shovel is produced of materials inexpensive enough such that the entire device is readily and fully disposable immediately after use.
